(19) United States
(12) Patent Application Publication
(10) Pub. No.: US 2012/0223531 A1
(43) Pub. Date: Sep. 6, 2012

(54) Generator Selection in a Power Plant

(75) Inventors: Alec Brooks, Pasadena, CA (US); Zvi Gershony, San Jose, CA (US)

(73) Assignee: GOOGLE INC., Mountain View, CA (US)

(21) Appl. No.: 13/038,665

(22) Filed: Mar. 2, 2011

(51) Int. Cl. H02P 9/14; F02N 11/08; H02K 7/18

(52) U.S. Cl. 290/1 R; 322/20; 290/34

(57) ABSTRACT

A power plant includes an engine coupled to a first generator and a second generator. The first generator includes a synchronous generator wherein the first generator is configured to provide reactive power to the second generator. The second generator includes an induction generator. One or more sensors are configured to measure a current output and a voltage output of the first and second generators, and a controller is configured to determine a power factor for the power plant based on the measured current output and voltage outputs. Based on the determined power factor, the controller adjusts the reactive power provided from the first generator to the second generator such that the power factor is maintained at a predetermined value.

### TECHNICAL FIELD

This specification relates to power generation, and more specifically to power generation using turbine engines.

### BACKGROUND

A “synchronous” generator runs at a constant speed and draws its excitation from a power source external or independent of the load or power grid it is supplying. A synchronous generator has an exciter that enables the synchronous generator to produce its own rotor excitation current and thus regulate its own voltage. Synchronous generators can operate in parallel with a utility or in “stand-alone” or “island” mode. When operated in grid parallel mode, synchronous generators can also be controlled to regulate power factor; they can provide leading or lagging reactive power through control of the rotor field current.

An “induction” generator, also known as an “asynchronous” generator, is generally spun by a rotational energy source (e.g., a turbine) at a rotational speed slightly above the synchronous speed of a power grid. Induction generators generally receive their initial excitation power from the grid or electric utility, for this reason, induction generators are generally run in parallel with the grid. The frequency and voltage of the power generated with induction generators are governed by the frequency and voltage of the incoming electric utility line.

The Brayton cycle (also known as a Joule cycle) is a thermodynamic cycle that describes the workings of various engines including, for example, a gas turbine engine and a jet engine. A Brayton cycle generally includes three main components: a gas compressor, a heat source, and an expansion turbine. Ambient air is generally drawn into the compressor, where it is pressurized. The compressed air then runs through a heating chamber that is open to flow in and out, where the air is heated in a constant-pressure process. The heated, pressurized air then gives up its energy by being expanded through a turbine. Some of the work extracted by the turbine is fed back and used to drive the compressor. The expanded air is then generally exhausted to the atmosphere.

### SUMMARY

In general, one innovative aspect of the subject matter described in this specification can be embodied in a system that includes the following. A power plant includes an engine coupled to a first generator and a second generator. The first generator is a synchronous generator and is configured to provide reactive power to the second generator. The second generator is an induction generator. The power plant further includes one or more sensors configured to measure a current output and a voltage output of the first and second generators. A controller included in the power plant is configured to determine a power factor for the power plant based on the measured current output and voltage outputs, and based on the determined power factor, adjust the reactive power provided from the first generator to the second generator, such that the power factor is maintained at a predetermined value.

These and other embodiments can each optionally include one or more of the following features. The predetermined value can be approximately 1.0. The engine can include a first compressor and a first turbine coupled to the first generator, and a second compressor and a second turbine coupled to the second generator. The second generator can be configured to operate as an induction motor during a start-up phase of the engine, and switch operation to an induction generator when the engine exceeds a self-sustaining operating point.

The engine can include a first compressor coupled to the first generator and configured to receive air at a first pressure and to output air at second pressure higher than the first pressure. A second compressor can be coupled to the second generator and configured to receive the output air from the first compressor and to output the air at a third pressure higher than the second pressure. A first heat source can be configured to transfer heat to the air output from the second compressor. A second turbine can be coupled to the second compressor and the second generator and configured to receive air heated by the first heat source and to output air expanded in the second turbine. A second heat source can be configured to transfer heat to the expanded air output from the second turbine. A first turbine can be coupled to the first compressor and the second generator and configured to receive air heated by the second heat source and to output air expanded in the first turbine. During the start-up phase of the engine, the second generator can operate as an induction motor operable to power the second compressor. The first heat source and the second heat source can include one or more receivers configured to receive solar energy from a plurality of heliostats.

In another innovative aspect of the subject matter described in this specification can be embodied in methods that include the following. A method includes providing mechanical energy to an induction generator of a power plant with engine, providing mechanical energy to a synchronous generator of the power plant with the engine, measuring current and voltage output from the induction generator and the synchronous generator, determining a power factor for power output from the power plant based on the measured current and voltage output, and selectively providing reactive power from the synchronous generator to the induction generator so as to maintain the power factor at a predetermined value.

These and other embodiments can each optionally include one or more of the following features. The predetermined value can be approximately 1.0. The engine can include a hot-air engine, and the method can also include heating air in the hot-air engine with solar energy. The method can also include operating the induction generator as an induction motor during a start-up phase of the engine, and providing energy from the induction motor to a compressor included in the engine. The engine can be a Brayton-cycle engine.

In another innovative aspect of the subject matter described in this specification can be embodied in methods that include the following. A method including compressing air from a first pressure to a second pressure higher than the first pressure with a first compressor and further compressing the air from the second pressure to a third pressure higher than the second pressure with a second compressor. The air output from the second compressor is heated with a first heat source and expanded in a second turbine. The second turbine is coupled to and transmits mechanical energy to an induction generator. Air output from the second turbine is heated with a second heat source and expanded in a first turbine. The first turbine is coupled to and transmits mechanical energy to a synchronous generator, measuring current and voltage output from the induction generator and the synchronous generator. A power factor is determined for power output from the induction generator and the synchronous generator based on the measured current and voltage output. Reactive power is selectively provided from the synchronous generator to the induction generator so as to maintain the power factor at a predetermined value.

Particular embodiments of the subject matter described in this specification can be implemented so as to realize one or more of the following advantages. The predetermined value can be approximately 1.0. Power plants may temporarily use induction generators as induction motors to start a power generation process before switching the motors over to generate power once the process is self-sustaining. The inductively started process can in turn be used to start a synchronous power production process and bring synchronous generators to grid frequency. Power plants may implement induction generators while avoiding penalties or costs associated with obtaining reactive power from a utility grid by selectively controlling the power factor of synchronous generators.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example power plant.

FIG. 2 is a block diagram of an example two-stage power plant system.

FIG. 3 illustrates an example heliostat field for use in power generation.

FIG. 4 is a flow diagram of an example start-up phase process.

FIG. 5 is a flow diagram of an example process for operating a two-stage generator system.

Like reference numbers and designations in the various drawings indicate like elements.

### DETAILED DESCRIPTION

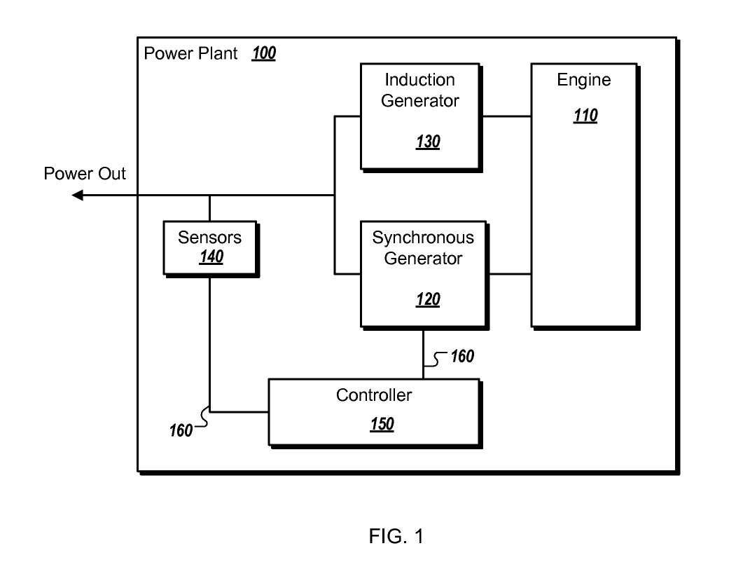

FIG. 1 is a block diagram of an example power plant 100. The power plant 100 includes an engine 110 coupled to a synchronous generator 120 and an induction generator 130. The engine 110 is a source of mechanical (e.g., rotational) energy that drives both the synchronous generator 120 and the induction generator 130. In some implementations, the engine 110 can be a turbine driven by heat (e.g., combustion, solar collection, geothermal energy), a rotor driven by kinetic energy (e.g., wind, water), or other appropriate mechanism that can drive the generators 120 and 130.

In operation, the synchronous generator 120 provides reactive power to the induction generator 130. In some implementations, by using a combination of both the induction generator 130 and the synchronous generator 120, the power plant 100 can take advantage of the relatively low capital costs generally associated with induction generators, while at the same time avoiding at least some of the capital costs and overhead expenses generally associated with providing the reactive power to inductive generators. Power utilities may charge or penalize a facility for consuming reactive power or for producing power that is not substantially at unity power factor. By using both the synchronous generator 120 and the induction generator 130 in a controlled system, reactive power consumption can be reduced or eliminated, while also maintaining a near-unity output power factor for the power plant 100. Additionally, in some implementations, the induction generator 130 can initially operate as an induction motor during a start-up phase of the engine 110. In other implementations, it may be desirable to maintain a power factor that is a predetermined value other than 1.0, which can also be achieved using the methods and systems described herein.

A sensor module 140 collects information from one or more sensors configured to measure a current output and a voltage output from the power plant generated by the synchronous generator 120 and the induction generator 130, as well as other appropriate inputs. This information is provided to a controller module 150, which can be communicably connected by a communications bus 160 to the sensor module 140 and to the synchronous generator 120. In some implementations, the communications bus 160 can be a wired communications bus. For example, the communications bus 160 can be an Ethernet network, an I2C network, an RS232/RS422 connection, or other appropriate wired connection. In another example, the communication bus 160 can be a fiber optic connection. For example, since fiber optic cables are substantially immune to even high levels of electromagnetic flux, fiber optics can be used for communication with and near the generators 120 and 130. In some implementations, the communications bus 160 can be a wireless network. For example, the communications bus 160 can be a wireless Ethernet (e.g., 802.11) network, a ZigBee network, a cellular network, or other appropriate wireless network.

The controller module 150 is configured to determine a power factor for the power plant 100 based on the current output and voltage outputs of the generators 120 and 130 as measured by the sensor module 140. For example, power factor (PF) can be expressed in terms of apparent power (VA) and the phase angle (theta) between the current and voltage waveforms as PF=VA * cos(theta). The controller module 150 can compare the current and voltage signals of the power plant's 100 output to determine the phase angle between the signals, and multiply the current and voltage values to determine apparent power. Once the phase angle and apparent power values have been determined, the controller module 150 can then determine the power factor of the power plant 100. The controller module 150 is configured to adjust the reactive power provided from the synchronous generator 120 to the inductive generator 130, based on the determined power provided from the synchronous generator 120, such that the power factor for the power plant 100 is maintained at approximately 1.0 (unity) or another predetermined value. For example, the controller module 150 can sense that the power plant 100 has an overall lagging PF of 0.9 lagging, due at least in part to the nature of the inductive generator 130. The controller module 150 may use the sensed lagging 0.9 PF value to determine that a leading 0.1 PF output is needed to bring the power plant's 100 overall PF substantially back to unity. To determine the amount of offset power factor to apply, the controller module 150 can account for the amounts of synchronous and inductive power production capacity available, the sizes of loads connected to the power plant 100, the power factor of the grid, and other appropriate factors. To accomplish the power factor offset, the controller module 150 may increase the amount of excitation power provided to the rotor of the synchronous generator 120 thereby causing the synchronous generator 120 to operate in a leading power factor. Similarly, the controller module 150 can decrease the amount of excitation power provided to the rotor of the synchronous generator 120 thereby causing the synchronous generator 120 to operate in a lagging power factor. By controllably adjusting the amount of excitation power provided to the synchronous generator 120, the controller module 150 can cause the synchronous generator 120 to produce the required amount of leading or lagging power factor needed to bring the overall output of the power plant 100 substantially to unity.

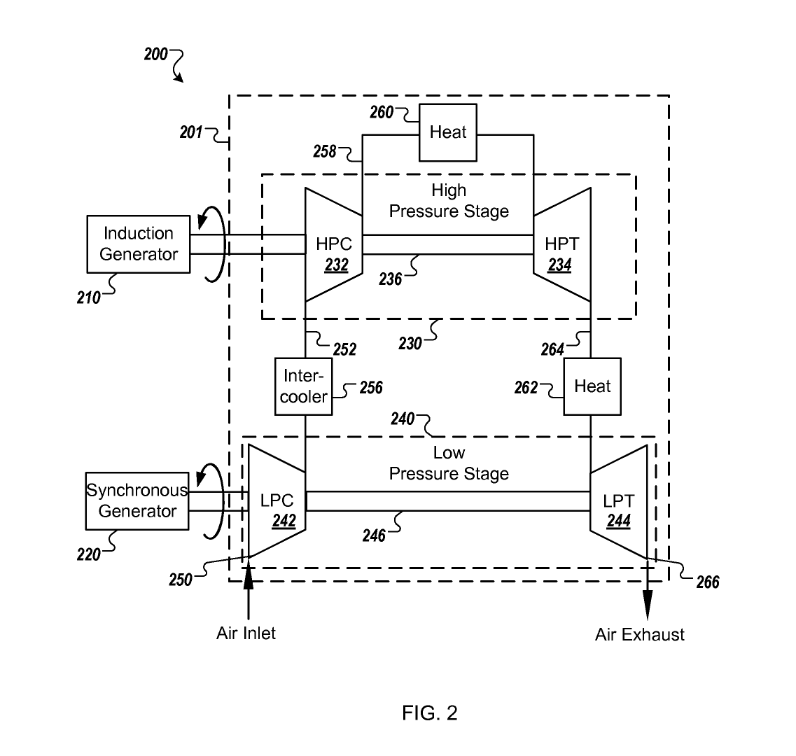

FIG. 2 is a block diagram of an illustrative example two-stage generator system 200 that can be used to implement the induction generator 130, synchronous generator 120 and engine 110 of FIG. 1, although it should be understood that other configurations of engine can be used to implement the engine 110. In this implementation, the induction generator 210 is coupled to a high pressure stage 230 of an engine 201. The high pressure stage 230 includes a high pressure compressor 232 and a high pressure turbine 234 coupled to each other and to the induction generator 210 by a rotatable shaft 236. The synchronous generator 220 is coupled to a low pressure stage 240. In some implementations, the high pressure stage 230 exit pressure can be about 2.5 to 5 times the exit pressure of the low pressure sage 240. The low pressure stage 240 includes a low pressure compressor 242 and a low pressure turbine 244 coupled to each other and to the synchronous generator 220 by a rotatable shaft 246. In some implementations, the low pressure stage 240 and the high pressure stage 230 may each be configured as Brayton-cycle engines as shown. While the present example is illustrated and described as having two stages, in some implementations any practical number of stages may be used. For example, three, four, five, ten, or more heat engines may be staged as described herein. Examples, of heat engines can include Brayton, Rankine, Stirling, and internal combustion engines.

In the illustrated example, ambient or otherwise substantially unpressurized air is drawn into the low pressure compressor 242 through an air inlet 250. The air is pressurized to a low pressure by the low pressure compressor 242, and is then provided to the high pressure compressor 232 through a low pressure conduit 252. The pressurization of the air by the low pressure compressor 242 heats the air, and in some implementations (as shown), an intercooler 254 can be provided to remove a portion of the heat from the air passing through the low pressure conduit 252.

The low pressure air is pressurized further by the high pressure compressor 232. The high pressure air is provided to a heat source 260 through a high pressure conduit 258. In some implementations, the heat source 260 can be a solar energy collection point wherein one or more solar heliostats may reflect and concentrate solar energy onto a collector (i.e., a receiver) configured to heat the high pressure air. In some implementations, the heat source 260 can be any appropriate source of heat energy that can be used to heat the high pressure air. For example, the heat source 260 can obtain heat energy from sources such as geothermal energy, nuclear power, combustion, or other appropriate energy source.

The heated, high pressure air is provided to the high pressure turbine 234 where it is allowed to expand. The expansion of the air through the high pressure turbine 234 urges the high pressure turbine 234 to rotate. The rotation of the high pressure turbine 234 urges rotation of the shaft 236, which in turn rotates the high pressure compressor 232 thereby causing the pressurization of the low pressure air entering the high pressure stage 230. The rotation of the shaft 236 also drives the induction generator 210 to generate electric power.

Through expansion in the high pressure turbine 234, some of the thermal energy of the air is lost. The expanded air is then provided to a heat source 262 through a conduit 264. The heat source 262 reheats the air flowing through the conduit 264. In some implementations, the heat source 262 may be substantially similar to the heat source 260. In some implementations, the heat source 260 and 262 may share a common heat source. For example, a heliostat field may concentrate solar energy on a receiver that provides both the heat source 260 and the heat source 262.

The reheated air is provided to the low pressure turbine 244 where the air is allowed to expand. The expansion of the air through the low pressure turbine 244 urges the low pressure turbine 244 to rotate. The rotation of the low pressure turbine 244 urges rotation of the shaft 246, which in turn rotates the low pressure compressor 242. The rotation of the low pressure compressor 242 causes the pressurization of the air entering the low pressure compressor 242 through the inlet 250. The rotation of the shaft 246 also drives the synchronous generator 220 to generate electric power. The air expanded through the low pressure turbine 244 is then exhausted through an air exhaust 266. In some implementations, the air exiting the low pressure turbine 244 may pass through a heat exchanger, where heat energy from the exhaust air can be at least partly recovered and provided back to the cycle just before heat source 260. In some implementations, the air exiting the low pressure turbine 244 which is coupled to the low pressure compressor 242 may pass through another turbine (i.e., a third turbine), in which implementations the synchronous generator can be coupled to the third turbine rather than the low pressure turbine 244.

The synchronous generator 220 is configured such that its power factor is controllable. In some implementations, the power factor of the synchronous generator 220 may be controlled by a controller, such as the controller module 150 of FIG. 1. For example, the power factor of the synchronous generator 220 can be controlled to provide leading, lagging, or unity power factor. This is accomplished by varying the rotor field current, which changes the flux from the rotor and hence the EMF of the machine. In general, there is one specific value of rotor field current that results in unity power factor. Increasing the field current results in a leading power factor, and decreasing the field current results in a lagging power factor. The degree of lead or lag is related to how much the rotor field current is moved away from the unity power factor operating point. The synchronous generator 220 is controlled to provide sufficient reactive power to satisfy the power requirements of the induction generator 210. Advantageously, the net power factor of the power plant can be kept substantially at unity without the use of capacitor banks or a static VAR compensator to provide reactive power for the induction generator 210.

In addition to functioning as a generator, the induction generator 210 is configured to also function as a starting motor. In some implementations, the induction generator 210 can be configured to also function as a motor with little or no additional electronics. For example, power from a utility, offline generator, may be used to operate the induction generator 210 as a motor during a startup phase of the two-stage generator system 200.

In some implementations, the slip characteristic of the induction generator 210 may be synergistic with the operation of a Brayton engine. For example, with an induction generator, torque increases rapidly as the speed increases above the synchronous speed. This speed versus torque characteristic may prove beneficial to the operation of the high pressure stage of the engine, which tends to operate at nearly constant speed over a broad range, and small speed changes may be all that are needed.

When operating as a starting motor, the induction generator 210 rotates the shaft 236, thus driving the high pressure compressor 232 and providing the initial rotational energy needed to start the Brayton cycle of the high pressure stage 230. For example, by using the induction generator 210 as a starting motor, air may be initially pressurized and caused to flow through the heat source 260 and on through the high pressure turbine 234 where the air expands and causes the high pressure turbine 234 to rotate, thus allowing heat from the heat source 260 to be converted to rotational energy at the shaft 236. Under normal operating conditions, heat energy from the heat source 260 is able to provide the energy needed to at least sustain the operation of the Brayton cycle of the high pressure stage 230 once started.

As the Brayton cycle starts, the high pressure turbine 234 begins to deliver rotational energy, which is in turn used to further drive the high pressure compressor 232 and the induction generator 210. As the rotational energy output by the shaft 236 of the high pressure stage 230 increases, the amount of torque applied to the shaft 236 by the induction generator 210 is reduced and eventually overtaken by the power provided by the high pressure turbine 234. As the high pressure stage 230 transitions from consuming torque on the shaft 236 to providing torque on the shaft 236, the induction generator 210 transitions from operating as a motor to operating as a generator.

Likewise, as the high pressure stage 230 starts, air exiting the high pressure turbine 234 is heated by the heat source 262 and flows through the low pressure turbine 244. This movement of heated air provides the energy needed to initialize the operation of the Brayton cycle of the low pressure stage 240. As the rotational speed of the shaft 246 increases, so too does the speed of the synchronous generator 220. When the output of the synchronous generator 220 matches the grid frequency, the synchronous generator 220 can be switched on to the grid, such that the electricity generated from the low pressure stage 240 is provided to the grid.

In some implementations, the air exiting the low pressure turbine 244 may pass through a heat exchanger (not shown). For example, heat from the air may be recuperated and reused by the heat sources 260 and/or 262. In some implementations, recovery and reuse of heat energy from the exhausted air can increase the overall efficiency of the system 200.

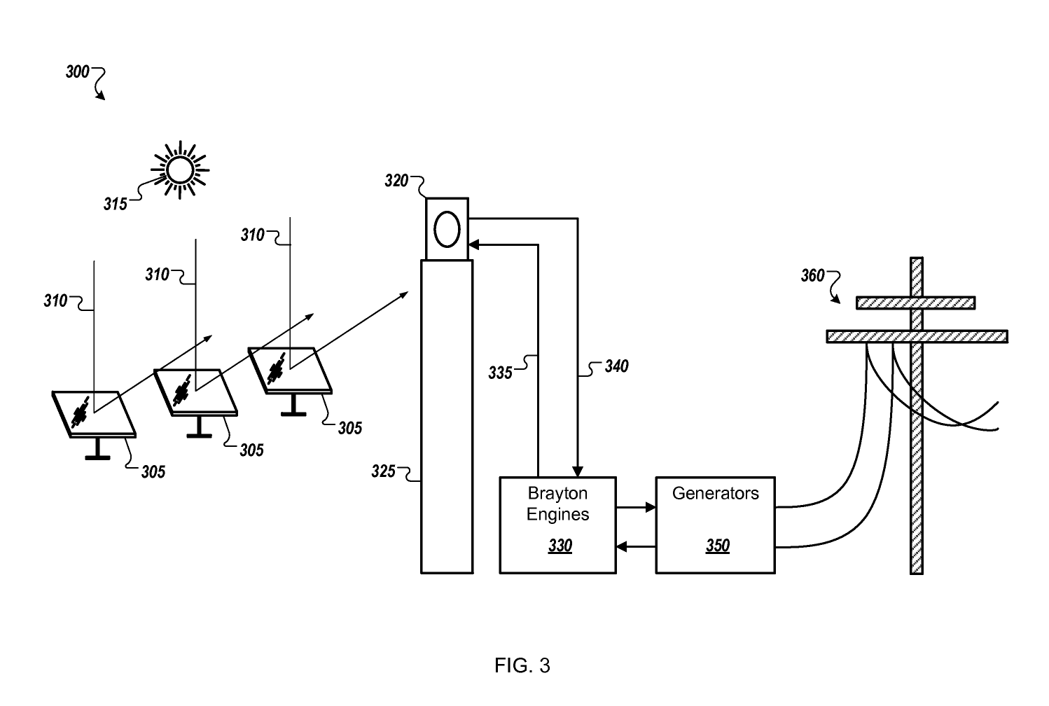

FIG. 3 illustrates an example heliostat field 300 for use in power generation. As mentioned previously, solar energy may be used to heat the air in an engine (e.g., a hot air engine, a Brayton engine) in order to generate electric power. The heliostat field 300 includes a number of heliostats 305. The heliostats 305 reflect solar rays 310 from the sun 315 onto a receiver 320 of a solar energy collection tower 325. The heliostats 305 each have a mirror that is configurable to be repositioned throughout the day to substantially maximize the amount of solar energy reflected from the mirror to the receiver 320.

An engine module 330 is coupled to the receiver 320 and to a generator module 350. The generator module 350 includes at least two generators, including an induction generator and a synchronous generator (e.g., the synchronous generator 220 and the induction generator 210 of FIG. 2). The engine module 330 uses solar energy from the receiver 320 to heat a fluid, e.g., air, that passes through one or more engines included in the engine module. In some implementations, the engine module 330 includes a Brayton engine such as that shown in FIG. 2 and described above. In such implementations, air is compressed in the engine module 330 and provided to the receiver 320 through a conduit 335. The compressed air is heated by the solar rays 310 concentrated upon the receiver 320, and the heated air is returned to the engine module 330 by a conduit 340. Within the engine module 330, the heated air spins a turbine, the rotational energy of which drives both the further compression of air by the compressor as well as a generator in a generator module 350. In a two-stage implementation, air is compressed in a first stage, compressed again in a second stage, and then heated by the receiver 320. The air then drives a turbine of the second stage before being provided to drive a turbine of the first stage. The first stage turbine also drives a synchronous generator (not shown) of the generator module 350, and the second stage turbine also drives an induction generator (not shown) included in the generator module 350. Power produced by the generator module 350 is provided to a utility grid 360.

In some implementations, air exiting the second stage turbine in the engine module 330 may be returned to the receiver 320 (e.g., via a separate conduit from the conduit 335) for re-heating before the air is provided to the first stage turbine. In some implementations, additional stages may be coupled to drive additional generators included in the generator module 350.

As previously described, the generator module 350 includes combinations of synchronous and induction generators. In some implementations, an induction generator can be used to start up the engine module 330. For example, the induction generator can easily be reconfigured to temporarily draw power from, rather than deliver power to, the utility grid 360, thereby acting as an induction motor during a start-up phase of the engine module 330. Rotational energy from the induction motor can be used to spin at least one compressor of the engine module 330, causing air to flow through the solar energy receiver 320. The heliostats 305 may then be brought on target (e.g., directing solar rays to the receiver 320) to heat the compressed air. Once the engine module 330 powers up, the induction motor can then switch operation in a substantially seamless manner to operate as an induction generator when the engine exceeds a self-sustaining operating point.

In some implementations, the synchronous generator of the generator module 350 can be controlled to provide reactive power to the induction generator. In some implementations, the synchronous generator can be controlled to produce lagging, leading, or unity power factor to offset the reactive power consumption of the induction generator and/or maintain a predetermined overall power factor for the power provided to the utility grid 360. For example, the utility grid 360 may be operating at a lagging power factor, and may communicate a request that the generator module 350 be operated to produce an at least partly offsetting leading power factor.

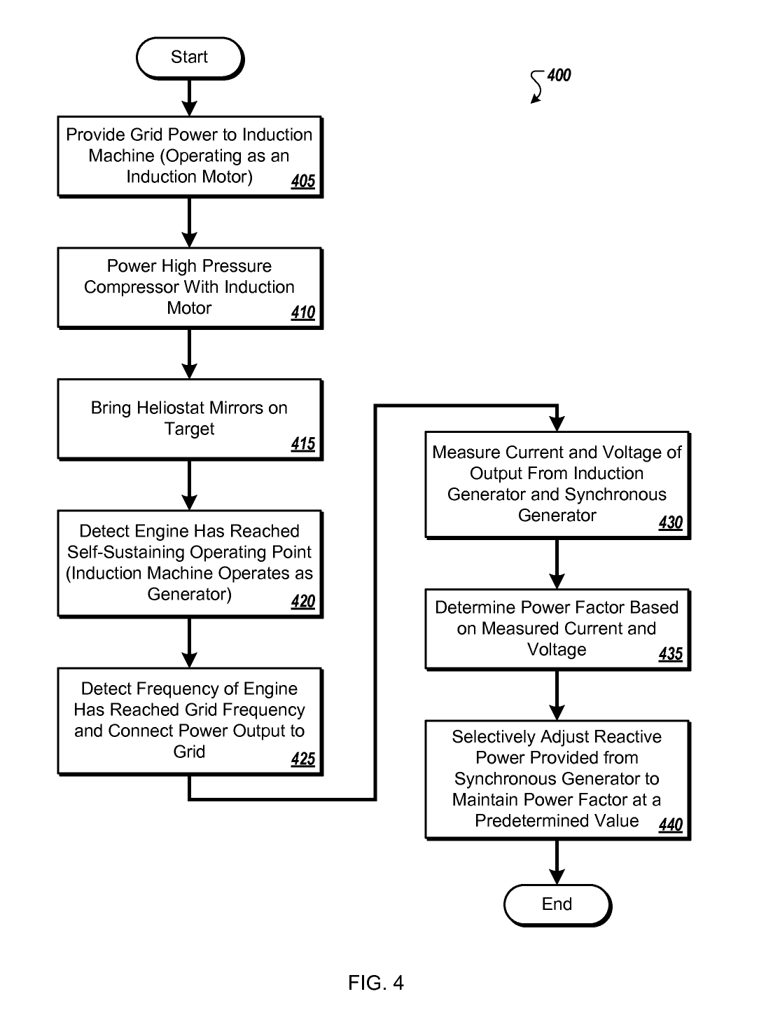

FIG. 4 is a flow diagram of an example start-up phase process 400. In some implementations, the process 400 may be used to start the operation of the power plant 100 of FIG. 1, the two-stage generator system 200 of FIG. 2, or the engine module 330 and the generator module 350 of FIG. 3. In general, an induction generator is operated as a motor to start a Brayton-cycle engine, and once the engine cycle becomes self-sustaining, the induction generator smoothly transitions to operating as a generator.

Initially, at step 405, grid power is provided to an induction machine operating as an induction motor. For example, electricity may be drawn from a grid to power the induction generator 210 as an induction motor. At step 410, a high pressure compressor is powered by the induction motor. For example, the high pressure compressor 232 is initially driven by the induction generator 210 to compress the air that is provided to the heat source 460.

At step 415, heliostat mirrors are brought on target. For example, the heliostats 305 may be angled to concentrate solar energy onto the receiver 320. As the solar energy heats the compressed air in the heat source 260, the Brayton cycle begins to produce rotational energy. In some implementations, sources of heat energy other than that collected by heliostat mirror may be used to heat the compressed air (e.g., combustible fuels, geothermal energy, chemical reactions, stored thermal energy).

At step 420, the engine is detected to have reached a self-sustaining operating point. For example, the controller module 150 can receive current and voltage measurements of the induction generator 130, provided by the sensor module 140, and determine that the induction generator 130 is operating as a generator rather than as a motor. As the Brayton cycle associated with the induction machine is started, the flow of air also causes the cycle of a second Brayton-cycle engine (e.g., the low pressure stage 240) associated with a synchronous generator (e.g., the synchronous generator 220) to begin as well. As the speed of the second engine increases, so too does the output frequency of the associated synchronous generator.

At step 425, the frequency of the second engine is detected to have reached grid frequency, and the power output of the associated synchronous generator is connected to the grid. At step 430, the current and voltage of the outputs from the induction and generator and the synchronous generator are measured. For example, the controller module 150 can process current and voltage measurements provided by the sensor module 140.

A power factor is determined at step 435 based on the measured current and voltage. For example, the controller module 150 may detect that the power plant 100 is providing a power factor of 0.97 lagging, and determine that a corrective power factor of 0.97 leading may be used to bring the overall power factor of the power plant 100 to unity (or some other predetermined value).

At step 440, the reactive power provided from the synchronous generator is selectively adjusted to maintain the power factor at the predetermined value (e.g., approximately 1.0). For example, the controller module 150 may use the previously determined corrective power factor of 0.97 leading to adjust the synchronous generator 120 produce power with a power factor of 0.97 leading. The power produced by the synchronous generator 120 can offset the 0.97 lagging power factor and cause the overall power output of the power plant 100 to have a power factor substantially at unity.

In some implementations, power production may be unevenly split between the synchronous generator and the induction generator, and this split can be taken into account for the determination of offset power factor. For example, the lagging generator can produce ⅔ of the total power at 0.97 lagging power factor, which would be balanced by a 0.94 leading power factor of the other generator.

In some implementations, grid operators or utilities can require power plants to operate at non-unity power factors in order to help regulate grid voltage and provide the reactive power needed. For example, power plants may be required to be able to provide between 0.95 leading and 0.95 lagging. In some implementations, the controller module 150 may receive a request from the operator of the utility grid 360 of FIG. 3 to operate the power plant 100 to provide a predetermined amount of leading or lagging power factor to the utility grid 360. For example, the utility grid 360 may be operating with a lagging power factor, and request that the power plant 100 be operated to output leading power factor. The controller module 150 can respond to such a request by adjusting the synchronous generator 120 such that the power plant 100 provides the utility grid 360 with power at a predetermined overall leading power factor.

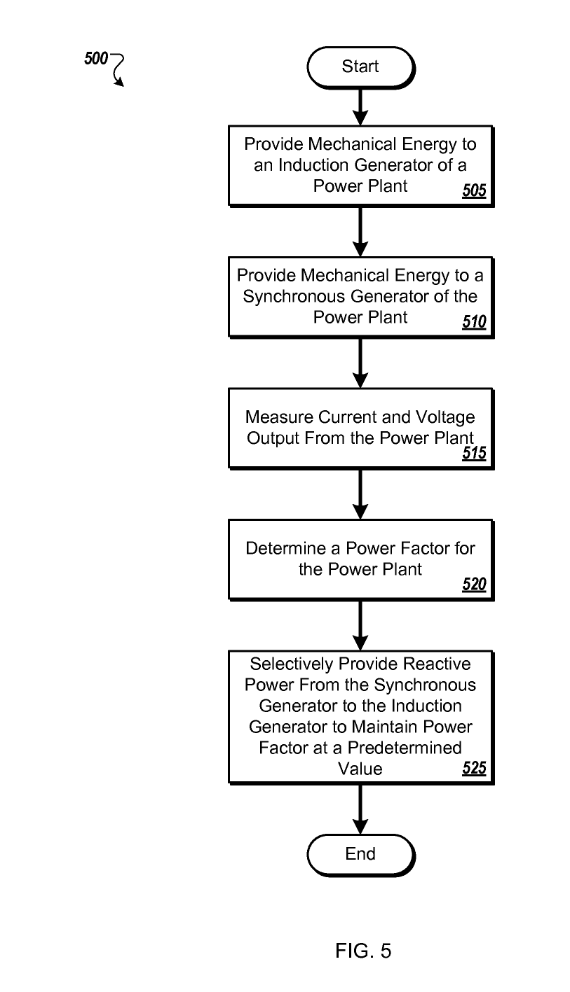

FIG. 5 is a flow diagram of an example process 500 for operating a two-stage generator system. In some implementations, the process 500 may be used for the operation of the power plant 100 of FIG. 1, the two-stage generator system 200 of FIG. 2, or the engine module 330 and the generator module 350 of FIG. 3.

At step 505, mechanical energy is provided to an induction generator of a power plant. For example, the engine 110 of FIG. 1 can drive the induction generator 130 of the power plant 100. At step 510, mechanical energy is provided to a synchronous generator of the power plant. For example, the engine 110 can drive the synchronous generator 120 of the power plant 100.

At step 515, the current and voltage output from the power plant is measured. For example, current and voltages sensed at the sensor module 140 can be provided to the controller module 150 as current and voltage readings that can be used for subsequent processing.

Based upon the measured current and voltage readings, or other appropriate source of information, a power factor of the power plant is determined at step 520. For example, the controller module 150 may process the current and voltage readings provided by the sensor module 140 to determine that the power plant 100 is operating at a power factor of 0.93.

At step 525, the synchronous generator is adjusted to selectively provide reactive power from the synchronous generator to the induction generator so as to maintain the power factor at a predetermined value. In an example in which the induction generator 130 is producing power at a power factor of approximately 0.93 lagging, the controller module 150 can adjust the power factor of the synchronous generator 120 to be approximately 0.93 leading assuming equal power for each generator, thus offsetting the lag caused by the induction generator 130 and causing the overall power factor of the power plant 100 to be substantially at unity or other predetermined value. In some implementations, the power factor of the synchronous generator 120 can be periodically re-adjusted in an attempt to compensate for non-unity power factors caused by variations within the power plant 100 or on the utility grid.

A number of embodiments have been described. Nevertheless, it will be understood that various modifications may be made without departing from the spirit and scope of the invention. For example, although the implementations described above use an engine driven by a Brayton cycle, other configurations of engines driven by other cycles can be used.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A power plant comprising:
an engine coupled to a first generator and a second generator;
the first generator comprising a synchronous generator, wherein the first generator is configured to provide reactive power to the second generator;
the second generator comprising an induction generator;
one or more sensors configured to measure a current output and a voltage output of the first and second generators;
a controller configured to:
determine a power factor for the power plant based on the measured current output and voltage outputs; and
based on the determined power factor, adjust the reactive power provided from the first generator to the second generator such that the power factor is maintained at a predetermined value.

2. The power plant of claim 1, wherein the predetermined value is approximately 1.0.

3. The power plant of claim 1, wherein the engine comprises:
a first compressor and a first turbine coupled to the first generator; and
a second compressor and a second turbine coupled to the second generator.

4. The power plant of claim 1, wherein the second generator is configured to:
operate as an induction motor during a start-up phase of the engine; and
switch operation to an induction generator when the engine exceeds a self-sustaining operating point.

5. The power plant of claim 4, wherein the engine comprises:
a first compressor coupled to the first generator and configured to receive air at a first pressure and to output air at second pressure higher than the first pressure;
a second compressor coupled to the second generator and configured to receive the output air from the first compressor and to output the air at a third pressure higher than the second pressure;
a first heat source configured to transfer heat to the air output from the second compressor;
a second turbine coupled to the second compressor and the second generator and configured to receive air heated by the first heat source and to output air expanded in the second turbine;
a second heat source configured to transfer heat to the expanded air output from the second turbine; and
a first turbine coupled to the first compressor and the second generator and configured to receive air heated by the second heat source and to output air expanded in the first turbine.

6. The power plant of claim 5, wherein:
during the start-up phase of the engine, the second generator operates as an induction motor operable to power the second compressor.

7. The power plant of claim 5, wherein:
the first heat source and the second heat source comprise one or more receivers configured to receive solar energy from a plurality of heliostats.

8. A method comprising:
providing mechanical energy to an induction generator of a power plant with engine;
providing mechanical energy to a synchronous generator of the power plant with the engine;
measuring current and voltage output from the induction generator and the synchronous generator;
determining a power factor for power output from the power plant based on the measured current and voltage output; and
selectively providing reactive power from the synchronous generator to the induction generator so as to maintain the power factor at a predetermined value.

9. The method of claim 8, wherein the predetermined value is approximately 1.0.

10. The method of claim 8, wherein the engine comprises a hot-air engine, the method further comprising:
heating air in the hot-air engine with solar energy.

11. The method of claim 8, further comprising:
during a start-up phase of the engine, operating the induction generator as an induction motor; and
providing energy from the induction motor to a compressor included in the engine.

12. The method of claim 8, wherein the engine comprises a Brayton-cycle engine.

13. A method comprising:
compressing air from a first pressure to a second pressure higher than the first pressure with a first compressor;
further compressing the air from the second pressure to a third pressure higher than the second pressure with a second compressor;
heating the air output from the second compressor with a first heat source;
expanding the heated air in a second turbine, wherein the second turbine is coupled to and transmits mechanical energy to an induction generator;
heating the air output from the second turbine with a second heat source; and
expanding the further heated air in a first turbine, wherein the first turbine is coupled to and transmits mechanical energy to a synchronous generator;
measuring current and voltage output from the induction generator and the synchronous generator;
determining a power factor for power output from the induction generator and the synchronous generator based on the measured current and voltage output; and
selectively providing reactive power from the synchronous generator to the induction generator so as to maintain the power factor at a predetermined value.

14. The method of claim 13, wherein the predetermined value is approximately 1.0.
